(19) United States
(12) Patent Application Publication
(10) Pub. No.: US 2010/0086797 A1
(43) Pub. Date: Apr. 8, 2010

(54) PROCESS

(75) Inventor: Mark Shane Spurlock, Somerset (GB)

Correspondence Address: PEARNE & GORDON LLP, 1801 EAST 9TH STREET, SUITE 1200, CLEVELAND, OH, 44114-3108, US

(73) Assignee: Bob Martin (UK) Limited, Yatton (GB)

(21) Appl. No.: 12/358,563

(22) Filed: Jan. 23, 2009

(30) Foreign Application Priority Data
Oct. 8, 2008 (GB) 0818461.6

(51) Int. Cl. B32B 9/04; B05D 3/02

(52) U.S. Cl. 428/497; 427/372.2; 428/411.1

(57) ABSTRACT

A process for making parasite repellent absorbent material, comprising:
a). spraying an absorbent material with a solution or suspension, said solution or suspension comprising at least one solvent and at least one parasite repellent to achieve a desired loading of the at least one parasite repellent;
b). drying the sprayed absorbent material so that the solvent present evaporates; and
c). storing the dried absorbent material away from direct sunlight for at least 24 hours to form parasite repellent absorbent material.

The parasite repellent absorbent material produced by this process may be used to make a parasite repellent collar.

This invention relates to a process for making parasite repellent absorbent material, more particularly parasite repellent absorbent material that may be used in a parasite repellent collar that may be worn by an animal, e.g. a pet.

Many animals have parasites with adult stages that live on the surface of their bodies, e.g. lice, fleas and ticks; these parasites bite the animal's skin and ingest its blood, often injecting foreign proteins with anticoagulant properties. This can irritate the animal, initiate allergic responses and may cause infections as well. Additionally the parasites can have a negative effect on any people the animal comes into contact with, or environments that the animal frequents. This issue is of greater significance when the animal is domesticated, e.g. a pet cat or dog, and lives in close contact with its owner. This is especially true if the domesticated animal lives in a heated environment, which enables parasites such as fleas to pose a potential problem all year round. Consequently, most pet owners treat their pets in some way to repel or eradicate the parasites. Such treatments include sprays, powders, injections and collars.

Most anti-parasitic or parasite repellent collars are made from plastic with the anti-parasitic compound or parasite repellent being released slowly over time. This confers residual efficacy as well as reducing the potential for toxicity in the animal wearing the collar. Such collars are usually made by mixing the anti-parasitic compound/parasite repellent with molten plastic then extruding the mixture to form a plastic anti-parasitic or parasite repellent collar.

The present invention offers a method of making parasite repellent absorbent material, which material may be used to make a parasite repellent collar or a parasite repellent pet bed liner.

In accordance with a first aspect of the present invention, there is provided a process for making parasite repellent absorbent material, said process comprising:
a). spraying an absorbent material with a solution or suspension, said solution or suspension comprising at least one solvent and at least one parasite repellent to achieve a desired loading of the at least one parasite repellent;
b). drying the sprayed absorbent material so that the solvent present evaporates; and
c). storing the dried absorbent material away from direct sunlight for at least 24 hours to form parasite repellent absorbent material.

Suitable solvents include aqueous solvents, such as water and non-aqueous solvents such as those selected from the list consisting of acetone, ethanol, isopropanol, ethyl acetate, and any combination thereof. A mix of aqueous and non-aqueous solvents may also be used. Suitable parasite repellents include those selected from the list consisting of margosa extract, ethyl butylacetylaminopropionate, diethyl toluamide (DEET), tea tree oil, coconut oil triglycerides, geraniol, and any combination thereof. Optionally, the parasite repellent may be partially or wholly microencapsulated to aid a slow release rate from the parasite repellent absorbent material formed by the claimed process and enhance residual efficacy.

Margosa extract (derived from the neem tree seed, Azadirachta indica) a natural product that has parasite repellent properties; the extract typically takes the form of an oil. The primary active substances within margosa extract are limonoids, such as azadirachtin, nimbin, meliantriol and salannin. Since margosa extract is a natural product the proportions of the limonoids within any particular sample can vary, the proportions of the limonoids are also affected by the process used to extract the active substances from the seeds. Therefore, in the context of the present application, the phrase “margosa extract” covers any product derived from the seeds of the neem tree which comprises one or more limonoids, specifically one or more of azadirachtin, nimbin, meliantriol and salannin, and combination thereof. However, because of the wide availability of neem seed extracts, the use of a standardized extract is typically preferred. Use of a standardized extract with standardized limonoid concentration ranges helps ensure the efficacy of the parasite repellent absorbent material produced by the claimed process.

Margosa extract is known to irritate the mouthparts of biting insects and disrupt the growth and reproduction of such parasites. For example, margosa extract is known to repel fleas, and to retard their growth, cause their eggs to fail to hatch, cause their larvae to fail to develop and to inhibit their feeding. One benefit of margosa extract is that it is of low mammalian toxicity and can be used with pregnant or nursing animals.

The inventors have found that collars produced using parasite repellent absorbent material made by the claimed process are particularly effective when the claimed process uses a solution or suspension comprising from 10% w/w to 45% w/w of the at least one parasite repellent, preferably about 18% w/w of the at least one parasite repellent. Optionally, the solution or suspension can further comprise at least one anti-oxidation compound, at least one fragrance or at least one UV screen. Suitable anti-oxidation compounds include those selected from the list consisting of butylated hydroxytoluene (BHT), butylated hydroxyanisole (BHA), tocopheryl acetate, propyl gallate, and any combination thereof. Suitable fragrances include those selected from the list consisting of tea tree oil, lavender oil, other synthetic fragrances suitable for use with species such as cat, and any combination thereof. Suitable UV screens include those selected from the list consisting of octylmethoxy cinnamate, ethylhexyl-p-methoxycinnamate, 2-ethoxyethyl-p-methoxycinnamate, cinoxate, and any combination thereof.

In one embodiment, the desired loading of the at least one parasite repellent ranges from 60 mg of solution or suspension per cm² of absorbent material to 75 mg of solution or suspension per cm² of absorbent material, preferably about 69 mg of solution or suspension per cm² of absorbent material.

In another embodiment, if the solvent is an aqueous solvent the absorbent material may be dried at a temperature of from 70° C. to 90° C., preferably from 75° C. to 85° C. Alternatively, if the solvent is a non-aqueous solvent the absorbent material may be dried at a temperature of from 30° C. to 45° C., preferably from 35° C. to 40° C. Optionally, the drying step involves two drying stages, the first stage at a higher temperature than the second stage. Additionally, the absorbent material may be dried for a length of time ranging from 10 minutes to 120 minutes, preferably about 30 minutes.

The inventors have found that the drying step is particularly effective when the absorbent material is dried in a sealed tank with a gaseous circulation system. The gaseous circulation system may use a pump to blow and/or suck gases through the sealed tank and the evaporated solvent may, optionally, be recovered and/or recycled.

The storing step is used to cure the dried absorbent material. Whilst the dried absorbent material is stored away from direct sunlight, the parasite repellent migrates into the absorbent material to produce a parasite repellent absorbent material that is less oily, and therefore more suited to further processing steps and for use in a collar or a pet bed liner. Although the dried absorbent material should be stored away from direct sunlight for at least 24 hours, this length of time can be increased to a period of at least 48 hours, at least 72 hours or even longer. The dried absorbent material may be stored at a temperature of 25° C. or less, optionally from 15° C. to 20° C.

The parasite repellent absorbent material produced by the claimed process may comprise from 5 mg of parasite repellent per cm² of absorbent material to 20 mg of parasite repellent per cm² of absorbent material, preferably about 12 mg of parasite repellent per cm² of absorbent material. Suitable absorbent materials include those selected from the list consisting of natural felt, synthetic felt, non-woven fabrics, super-absorbent polymer and any combination thereof. Optionally the absorbent material is polyester felt. Various thicknesses and densities of absorbent material can be used in the present invention, for example the absorbent material may be from 1 mm to 5 mm thick, preferably 3 mm thick and the absorbent material may have a density of from 300 g/m² to 600 g/m², preferably about 450 g/m².

The absorbent material may be laminated on one side, optionally with a coloured and/or reflective material. The colour and/or reflective qualities of the laminate add to the decorative and/or safety features to any collar made using the parasite repellent absorbent material of the present invention. The laminate material may be plastic, e.g. polyurethane.

The storing step has been found to be helpful in preventing the delamination of laminated absorbent material. The type of absorbent material used, the quantity of solvent used, the drying conditions and the storage conditions can all affect delamination of laminated absorbent material.

Once the parasite repellent absorbent material has been made the material can be processed further to make a parasite repellent collar or a parasite repellent pet bed liner. Such a collar can incorporate fastening means, such as a buckle, adjustment means, such as elastic, and additional features, such as a bell. Such a pet bed liner could help with control of parasites in a domesticated animal's environment. The liner may be disposable and may incorporate a cover, e.g. a loosely woven fabric, which cover allows the parasite repellent to be released slowly over time.

In order that the invention may be more fully understood the following non-limiting Examples are provided by way of illustration only.

### EXAMPLE 1

### Preparation of 18% w/w Margosa Extract Solution

The solution was manufactured using the following components:

TABLE 1.1
Margosa extract solution components

| | | Amount required |
|---|---|---|
| Component | % w/w | per 1 kg batch |
| Margosa extract | 18.00 | 180.00 g |
| Butylated hydroxytoluene (BHT) | 0.025 | 0.25 g |
| Acetone | 81.975 | 819.75 g |

The components were dispensed in the order shown in table 1.1, with brief mixing (approximately 1-2 minutes) to dissolve the BHT. The solution formed was clear and amber-coloured, with no suspended particles and a characteristic (garlic-like) odor.

The BHT used was of Ph Eur quality and the acetone was a laboratory reagent grade, >99.5%. The Margosa extract was sourced from Terra Nostra GmbH.

### EXAMPLE 2

### Spraying of Felt with the 18% w/w Margosa Extract Solution

The Margosa extract solution of Example 1 was delivered using a calibrated trigger spray pack set to ‘spray’ to a sample of laminated felt measuring 20 cm×20 cm (400 cm²) to achieve a desired loading of the Margosa extract of about 69 mg of solution per cm² of the felt.

### EXAMPLE 3

### Drying of the Sprayed Felt

The sprayed felt from Example 2 was placed in a sealed tank with a gaseous circulation system, which tank had been pre-warmed to 35° C. The following observations were recorded:

TABLE 3.1
Drying conditions and observations

| Time | Temperature | Weight of felt |
|---|---|---|
| 0 min | 35° C. | 55.5 g |
| 30 min | 35° C. | 37.5 g |
| 60 min | 35° C. | 37.5 g |

### EXAMPLE 4

### Storing of the Dried Felt

After 60 minutes of drying the felt was removed to ambient storage (approximately 18° C).

The upper surface of dried felt was off-white/pale yellow and oily to the touch, but following 48 hours of storage at ambient temperature the felt was whiter in appearance and felt dry.

1. A process for making parasite repellent absorbent material, said process comprising:
a). spraying an absorbent material with a solution or suspension, said solution or suspension comprising at least one solvent and at least one parasite repellent to achieve a desired loading of the at least one parasite repellent;
b). drying the sprayed absorbent material so that the solvent present evaporates; and
c). storing the dried absorbent material away from direct sunlight for at least 24 hours to form parasite repellent absorbent material.

2. A process according to claim 1, wherein the at least one solvent is selected from the list consisting of aqueous solvents, such as water, and non-aqueous solvents selected from the list consisting of acetone, ethanol, isopropanol, ethyl acetate, and any combination thereof.

3. A process according to claim 1, wherein the at least one parasite repellent is selected from the list consisting of margosa extract, ethyl butylacetylaminopropionate, diethyl toluamide, tea tree oil, coconut oil triglycerides, geraniol, and any combination thereof.

4. A process according to claim 1, wherein the solution or suspension comprises from 10% w/w to 45% w/w of the at least one parasite repellent, preferably about 18% w/w of the at least one parasite repellent.

5. A process according to claim 1, wherein the solution or suspension further comprises at least one anti-oxidation compound.

6. A process according to claim 5, wherein the at least one anti-oxidation compound is selected from the list consisting of butylated hydroxytoluene, butylated hydroxyanisole, tocopheryl acetate, propyl gallate, and any combination thereof.

7. A process according to claim 1, wherein the solution or suspension further comprises at least one fragrance.

8. A process according to claim 7, wherein the at least one fragrance is selected from the list consisting of tea tree oil, lavender oil, other synthetic fragrances suitable for use with species such as cat, and any combination thereof.

9. A process according to claim 1, wherein the desired loading of the at least one parasite repellent ranges from 60 mg of solution or suspension per cm² of absorbent material to 75 mg of solution or suspension per cm² of absorbent material.

10. A process according to claim 1, wherein the solvent is an aqueous solvent and the absorbent material is dried at a temperature of from 70° C. to 90° C., preferably from 75° C. to 85° C.

11. A process according to claim 1, wherein the solvent is a non-aqueous solvent and the absorbent material is dried at a temperature of from 30° C. to 45° C., preferably from 35° C. to 40° C.

12. A process according to claim 1, wherein the absorbent material is dried for a length of time ranging from 10 minutes to 120 minutes, preferably about 30 minutes.

13. A process according to claim 1, wherein the absorbent material is dried in a sealed tank, which tank has a gaseous circulation system.

14. A process according to claim 13, wherein the gaseous circulation system uses a pump to blow and/or suck gases through the sealed tank.

15. A process according to claim 13, wherein the gaseous circulation system enables the evaporated solvent to be recovered and/or recycled.

16. A process according to claim 1, wherein the dried absorbent material is stored away from direct sunlight for a period of at least 48 hours.

17. A process according to claim 1, wherein the dried absorbent material is stored at a temperature of 25° C. or less.

18. A process according to claim 1, wherein the parasite repellent absorbent material comprises from 5 mg of parasite repellent per cm² of absorbent material to 20 mg of parasite repellent per cm² of absorbent material, preferably about 12 mg of parasite repellent per cm² of absorbent material.

19. A process according to claim 1, wherein the absorbent material is selected from the list consisting of natural felt, synthetic felt, non-woven fabrics, super-absorbent polymer and any combination thereof.

20. A process according to claim 1, wherein the absorbent material is from 1 mm to 5 mm thick, preferably 3 mm thick.
